(19) United States
(12) Patent Application Publication
(10) Pub. No.: US 2024/0159697 A1
(43) Pub. Date: May 16, 2024

(54) METHOD FOR PREDICTING THE RESTART OF PARAFFINIC OIL FLOW

(71) Applicants: PETRÓLEO BRASILEIRO S.A. - PETROBRAS, Rio de Janeiro (BR); UNIVERSIDADE FEDERAL DO RIO DE JANEIRO, Rio de Janeiro (BR)

(72) Inventors: MARCIA CRISTINA KHALIL DE OLIVEIRA, Rio de Janeiro (BR); MÁRCIO NELE DE SOUZA, Rio de Janeiro (BR); ANTONIO MAURICIO CHAGAS MACIEL, Rio de Janeiro (BR); ANDRÉ DA SILVA GUIMARÃES, Rio de Janeiro (BR); THIAGO OLIVEIRA MARINHO, Rio de Janeiro (BR); PRÍAMO ALBUQUERQUE DE MELO JUNIOR, Rio de Janeiro (BR)

(73) Assignee: PETRÓLEO BRASILEIRO S.A. - PETROBRAS, Rio de Janeiro (BR)

(21) Appl. No.: 18/504,800

(22) Filed: Nov. 8, 2023

(30) Foreign Application Priority Data
Nov. 9, 2022 (BR) BR1020220228019

(51) Int. Cl. G01N 25/48; G06F 30/28; G06F 111/10; G06F 113/08; G06F 119/08; G06F 119/14

(52) U.S. Cl. CPC G01N 25/4873; G06F 30/28; G06F 2111/10; G06F 2113/08; G06F 2119/08; G06F 2119/14

(57) ABSTRACT

The present invention relates to a method for predicting the restart of paraffinic oil flow by being able to estimate the precipitated paraffin fraction under conditions of production stoppage through differential scanning calorimetry (DSC) tests and rheological evaluation, to predict the yield stress (TLE) profiles in pipes containing gelled paraffinic petroleum and the time interval until line blockage formation (available waiting time—TED).

### CROSS REFERENCE TO RELATED APPLICATION

The application claims, under 35 U.S.C. § 119(a), priority to and the benefit of Brazilian Patent Application No. BR 10 2022 022801 9, filed Nov. 9, 2022, which is incorporated by reference herein in its entirety.

### FIELD OF THE INVENTION

The present invention relates to a method for predicting the restart of paraffinic oil flow by being able to estimate the paraffin precipitated fraction under conditions of production stoppage. This estimate is carried out through a simple equation with few parameters, which are obtained through differential scanning calorimetry (DSC) tests and rheological evaluation, to predict the yield stress (TLE) profiles in gelled paraffinic oil-containing pipes.

The method of the present invention is applicable in maritime oil production fields, more specifically in the flow assurance area of paraffinic oils and can be incorporated into flow assurance and computational fluid dynamics simulators to predict stress fields and production stoppage time.

### INVENTION BACKGROUND

Paraffinic crude oil contains significant amounts of paraffin compounds. These molecules are hydrocarbon mixtures known to produce a gel-like structure under specific circumstances when cooled below a critical temperature, known as the Initial Crystal Appearance Temperature (TIAC). The paraffin content may vary depending on the origin of the crude oil, however, there is evidence that with as little as 2.0% by mass of precipitated paraffin, gelling can occur (Hansen et al. [1]).

Furthermore, offshore oil production in deep waters involves numerous challenges, including the safe and efficient transportation of oil from the reservoir rock to the production platform. In this sense, paraffin precipitation and deposition cause detrimental effects on several aspects of crude oil processing. Paraffinic deposits formed on the pipe internal walls exposed to the low temperatures of the seabed increase in thickness and stiffness over time and limit the oil flow, increasing load losses necessary to produce it.

Furthermore, cooling, especially in quiescent conditions, such as during production stoppage, can lead to the appearance of a gelled structure. The formation of this structure in its turn causes drastic changes in the rheological properties of the fluid, such as the appearance of a yield stress (TLE) (Visintin et al. [2] and Paso et al. [3]). In these cases, restarting the production flow is only viable with the imposition of a pressure greater than the TLE. If the pressure available in the installation is lower than the TLE, the gel formed in the subsea line will block production, causing significant losses. In these cases, it is necessary to look for other ways to remedy the line blockage. Therefore, predicting the TLE value appropriately and the time to form the blockage is fundamental information for predicting operational conditions for restarting flow in paraffinic oil production fields.

Therefore, ensuring the flow of crude paraffinic oil is a major concern for the oil industry, especially on offshore platforms. On these platforms, paraffin precipitation and deposition is one of the widespread problems in oil industry operations around the world, with paraffin deposits creating problems from the wellhead to the refinery. Furthermore, these problems arise even when the oil is not in a completely gelled state. Thus, operations are hampered by the precipitation and deposition of paraffin in the well, in the pipes, in the drilling equipment, in the pump columns and rods, in addition to the transfer system and pipes (D. Tukenov [4]). The consequences are equipment failures, bottlenecks along the pipeline and loss of production, transportation and storage capacity, resulting in risky operations and lost revenue.

Currently, the prediction of production flow restart is often carried out by simulating the temperature profiles in the pipe during cooling. These profiles provide an estimate of the advancement of the crystallization frontier with time, as discussed in Bhat and Mehrotra [5], based on prior knowledge of the Initial Crystal Appearance Temperature (TIAC).

A second approach applied is the use of thermodynamic models to predict the precipitated fraction through direct correlations with temperature and pressure. Despite the validity of this approach, the thermodynamic models adopted are usually complex and depend on knowledge of information such as the distribution of the number of carbons of the paraffins present in the oil (Fleming et al. [6]). This distribution is obtained through gas chromatography experiments which can be noisy and difficult to read for crude oils.

Another relevant approach is that described in Mendes et al. [7], which presents a methodology for calculating yield stress (TLE) profiles in pipes containing gelled paraffinic oil. However, the stress profiles are obtained by direct correlations with the local temperature in the tube and the crystal appearance temperature (TIAC) of the oil, making it important in this scenario to apply kinetic models to predict the precipitated paraffin fraction.

Some kinetic models based on Avrami and Ozawa's theory are found in the literature (Zougari and Sopkow [8]). In this class of models, the kinetics are based on the crystallinity degree obtained from differential scanning calorimetry (DSC) experiments. But despite the validity of the model presented by Zougari and Sopkow [8], there is no mention of its application during stoppage problems.

In this sense, it is noted that differential scanning calorimetry (DSC) is an important technique applied to studies of oil paraffin precipitation in the context of flow assurance. This technique measures the heat flow to or from the sample when it is heated or cooled. Since crystallization releases heat, it will appear on the DSC curve as an exothermic peak during cooling. Thus, it is possible to quantify the thermal effects and measure thermodynamic data of paraffins. DSC is generally used to evaluate paraffin inhibition by heat flow, measurement of TIAC or to determine the mass fraction of crystals formed during cooling under quiescent conditions as a function of temperature.

The study by Zhao et al. [9] evaluates the thermal behavior of paraffinic oils using thermogravimetric analysis (TG) and differential scanning calorimetry (DSC) techniques. Despite belonging to the same field as the proposed invention and making a correlation between the solid fraction of precipitated paraffin with the yield stress under production stoppage/restart conditions, Zhao et al. [9] does not take into account the paraffin fractions in the liquid phase. Furthermore, the yield stress calculation proposed by the Authors does not reconcile the precipitated paraffin fractions with the gel morphology and rheological properties.

Additionally, Zhao et al. [10] used DSC to investigate the effect of cooling rate, paraffin content, asphaltene and chemical additive on the TIAC of paraffinic oils and model crude oils. The results indicated that TIAC increases with increasing paraffin content. This confirms the greater precipitation in samples with higher paraffin content during the gelling process. However, the effect of pour point depressants on TIAC was greater than the other factors investigated.

Patent document FR 2976670 refers to a method for estimating the conditions for restarting the paraffinic oil flow in pipelines used to transport hydrocarbons and involves simulating the restart phase and evaluating the value of the hydrocarbon recirculation pressure in the pipeline. Although this is also associated with a methodology to calculate the ideal conditions for restarting production, the aforementioned document does not disclose or even suggest a kinetic model that reconciles the precipitated paraffin fractions and obtains the appropriate yield stress, taking into account the viscoelastic properties of paraffinic oils under cooling conditions inside the pipes.

Thus, the proposed method, object of the present invention, is an advance in the calculation of the yield stress in the tube due to the possibility of reconciling the precipitated paraffin fractions with the gel morphology through the fractal dimension property and with the rheological properties proposed by Shih et al. [11]. This new approach allows the results obtained to be interpreted as a function of time, by a kinetic model, through a consistent technical-scientific framework, thus providing reliability to the proposed method.

### SUMMARY OF THE INVENTION

The present invention aims to reduce oil production losses resulting from the blockage of submarine lines as well as assist in reducing the costs of blockage remediation operations, which in extreme cases may require the replacement of part of the pipeline with gelled material. It is estimated that in these cases the cost of a single maintenance can reach around 30 million dollars (Huang et al. [12]).

Furthermore, the present invention aims to estimate the yield stress (TLE) to determine whether the pressure available in the installation for pumping the fluid in the line is capable of promoting the restart of flow. Finally, the information provided by the method is also useful for defining the premises of new production projects, being applicable to all maritime production fields.

The solution achieved by the proposed method is the possibility of predicting the precipitated paraffin fraction, under production stoppage conditions, through a simple equation with few parameters, which are obtained through differential scanning calorimetry tests and rheological evaluation, to predict yield stress profiles as a function of time in pipes containing gelled paraffinic oil. The time required for line blockage formation can also be obtained.

### BRIEF DESCRIPTION OF FIGURES

The present invention will be described below, with reference to the attached figures which, in a schematic way and not limiting the inventive scope, represent examples of implementation thereof.

FIG. 1 illustrates the representation of the pipe cross section, as shown in FIG. 1 published in Mendes et al. [7].

FIG. 2 illustrates the radial profiles of temperature (graph a), liquid paraffin fraction (graph b), crystallized paraffin fraction (graph c) and cooling rate for a crude paraffinic oil in a pipe, with a thermal exchange coefficient of U=1 W/m²K (graph d), as a function of time.

FIG. 3 illustrates the evolution of the average properties of the oil referred to in FIG. 2, in quiescent cooling, through the crystallized paraffin fraction (graph a), liquid paraffin fraction (graph b), average temperature profiles (graph c) and cooling rate for thermal exchange coefficients between 0.5 to 2 W/(m²K) (graph d) as a function of time.

FIG. 4 illustrates radial yield stress profiles in the tube (U=1 Wm²/K) as a function of paraffin content and time.

FIG. 5 illustrates average yield stress profiles in the tube for different heat exchange coefficients.

### DETAILED DESCRIPTION OF THE INVENTION

The present invention relates to a method for predicting the restart of paraffinic oil flow capable of determining the yield stress (TLE) through the parameters of differential scanning calorimetry (DSC) tests and rheological evaluation of precipitated paraffin fraction under production stoppage conditions. Therefore, the invention is capable of estimating the yield stress (TLE) value appropriately and the time interval until the formation of the line blockage (i.e., the available waiting time), so as to guarantee the supply of accurate information on the operational conditions for restarting production of paraffinic oil production fields.

This estimate is made through equations 1 to 5, which reproduce the heat flow data (θ) corresponding to the phase transition of paraffins obtained by calorimetric analysis and obtaining the precipitated paraffin fraction (ϕ_{PS}).

$$\\ \begin{matrix}\frac{d {ϕ}_{PS}}{dT} = k ( {ϕ}_{0} - {ϕ}_{PS} ) , {ϕ}_{PS} ( {T}_{inicial} ) = 0 & ( Eq . 1 )\end{matrix}$$

$$\\ \begin{matrix}θ = Δ {h}_{c} q \frac{d {ϕ}_{PS}}{dT} , θ ( 0 ) = 0 & ( Eq . 2 )\end{matrix}$$

$$\\ \begin{matrix}T = - qt + {T}_{inicial} & ( Eq . 3 )\end{matrix}$$

$$\\ \begin{matrix}k = \frac{{k}_{AT} {k}_{AR}}{{k}_{AT} + {k}_{AR}} & ( Eq . 4 )\end{matrix}$$

$$\\ \begin{matrix}{k}_{AT} = {A}_{AT} exp [ \frac{- {E}_{AT}}{R ( {T}_{inicial} - T )} ] & ( Eq . 5 )\end{matrix}$$

Equation 1 represents the balance of precipitated paraffin fraction (ϕ_{PS}) as a function of temperature (T), which depends on a proportionality constant (k), the paraffin fraction in the oil (ϕ₀) and an initial condition (ϕ_{PS}(T_{inicial})=0).

Equation 2 represents the latent heat balance (θ) released by the sample during crystallization, which depends on the crystallization enthalpy of pure paraffin (Δh_{c}=200 J/g), the cooling rate (q=−dT/dt) and an initial condition (θ (0)=0).

Equation 3 describes the linear temperature dynamics for cooling in DSC obeying the cooling rate imposed in the experiment (0.4 to 1.2° C./min), while Equations 4 and 5 describe the proportionality constant (k). This constant, in its turn, depends on a coefficient (k_{AR}) and an activation function (k_{AT}).

Regarding the values of the parameters used, the initial temperature (Tᵢₙᵢₜᵢₐₗ) was determined as the Initial Crystal Appearance Temperature (TIAC) plus three (Tᵢₙᵢₜᵢₐₗ=TIAC+3), obtained by calorimetry tests.

The other parameters, namely, k_{AR}, A_{AT}, E_{AT}/R and ϕ₀ were determined by the parameter estimation procedure adopted. In this procedure, based on data on time or temperature, heat flow and cooling rate, data on the fraction of precipitated paraffin are obtained indirectly, from Equation 1.

The estimation of the kinetic parameters, used in Equations 1 to 5, can be carried out using any commercial software or programming language, which allows the resolution of an algebraic-differential model and the application of an optimization method to minimize the square minimum function. Some examples include Matlab, FORTRAN, and Python languages.

To predict the yield stress (TLE) in pipes, a rheological assessment is carried out based on oscillatory stress amplitude scanning tests in rheometers for temperatures below the gelling temperature, as described in the works of Guimarães [13] and Marinho [14], in conjunction with differential scanning calorimetry tests. Then, a stress model based on the scaling theory of Shih et al. [11] is applied to adjust the precipitated paraffin fraction data, previously obtained in equations 1 to 5, with the rheological data, according to Equation 6. This model has two parameters to be adjusted, a proportionality factor (C_{τ}) and a structure factor, called fractal dimension (D):

$$\\ \begin{matrix}{τ}_{c} = {C}_{τ} {ϕ}_{PS}^{{}^{} A} , A = \frac{2}{3 - D} & ( Eq . 6 )\end{matrix}$$

Finally, the equations 2 can be incorporated into flow assurance and/or computational fluid dynamics simulators to predict stress profiles and available waiting time and define the conditions for restarting production in prolonged stoppage conditions. In general, the Marlim Transiente simulator, developed by Petrobras, can be used. However, other commercial flow simulators well known in the art can also be used.

Regarding the estimation of the parameters, in the present case, the non-commercial software called ESTIMA was used, in the FORTRAN programming language, developed in the Chemical Engineering Program at the Federal University of Rio de Janeiro. In this sense, it is noteworthy that time or temperature and heat flow data are provided to the estimator, and as a result of the optimization procedure, the model parameters are determined, whose suitability to the data can be evaluated by statistical parameters such as the determination coefficient R².

Furthermore, the equation corresponding to the cooling of a pipe section is described in Equations 7 to 18.

Energy Balance:

$$\\ \begin{matrix}ρ {C}_{p} \frac{\partial T}{\partial t} = \frac{1}{r} \frac{\partial }{\partial r} ( {rk}_{eff} \frac{dT}{dr} ) + ρ Δ {h}_{c} {R}_{ϕ} & ( Eq . 7 )\end{matrix}$$

$$\\ \begin{matrix}t = 0 ∴ T ( 0 , r ) = {T}_{0} , ∀ r & ( Eq . 8 )\end{matrix}$$

$$\\ \begin{matrix}r = 0 ∴ \frac{\partial T}{\partial r} ( t , 0 ) = 0 , ∀ t & ( Eq . 9 )\end{matrix}$$

$$\\ \begin{matrix}r = {r}_{0} ∴ - {k}_{eff} \frac{\partial T}{\partial r} ( t , {r}_{0} ) = U ( T ( t , {r}_{0} ) - {T}_{∞} ) , ∀ t & ( Eq . 10 )\end{matrix}$$

in which, T is the temperature, t is the time, ρ is the mixture density, Cₚ is the heat capacity of the mixture, R_{ϕ} is the source term corresponding to the kinetic model, r is the radial component, k_{eff} is the thermal conductivity of the mixture, U is the heat exchange global coefficient, T_{∞} is the seabed temperature and T₀ is the initial temperature of the fluid.

In equations 11 to 14 there is the balance of paraffin in the liquid phase (ϕ_{PL}), in which D_{iff} is the mass diffusivity of paraffin in the liquid phase and ϕ_{PL,0} is the initial fraction of paraffin in the liquid phase.

$$\\ \begin{matrix}\frac{\partial {ϕ}_{PL}}{\partial t} = \frac{1}{r} \frac{\partial }{\partial r} ( {rD}_{iff} \frac{\partial {ϕ}_{PL}}{\partial r} ) - {R}_{ϕ} & ( Eq . 11 )\end{matrix}$$

$$\\ \begin{matrix}t = 0 ∴ {ϕ}_{PL} ( 0 , r ) = {ϕ}_{PL , 0} , ∀ r & ( Eq . 12 )\end{matrix}$$

$$\\ \begin{matrix}r = 0 ∴ \frac{\partial {ϕ}_{PL}}{\partial r} ( t , 0 ) = 0 , ∀ t & ( Eq . 13 )\end{matrix}$$

$$\\ \begin{matrix}r = {r}_{0} ∴ \frac{\partial {ϕ}_{PL}}{\partial r} ( t , {r}_{0} ) = 0 , ∀ t & ( Eq . 14 )\end{matrix}$$

In equations 15 to 18, there are the precipitated paraffin balance (ϕ_{PS}):

$$\\ \begin{matrix}\frac{\partial {ϕ}_{PS}}{\partial t} = {R}_{ϕ} & ( Eq . 15 )\end{matrix}$$

$$\\ \begin{matrix}t = 0 ∴ {ϕ}_{PS} ( t , r ) = 0 ∀ r & ( Eq . 16 )\end{matrix}$$

$$\\ \begin{matrix}T \geq {T}_{inicial} ∴ {R}_{ϕ} = 0 & ( Eq . 17 )\end{matrix}$$

$$\\ \begin{matrix}T < {T}_{inicial} ∴ {R}_{ϕ} = ( - \frac{\partial T}{\partial t} ) k ( T ) ( {ϕ}_{PL} - {ϕ}^{*} ( T ) ) & ( Eq . 18 )\end{matrix}$$

### Example of Implementation/Tests/Results

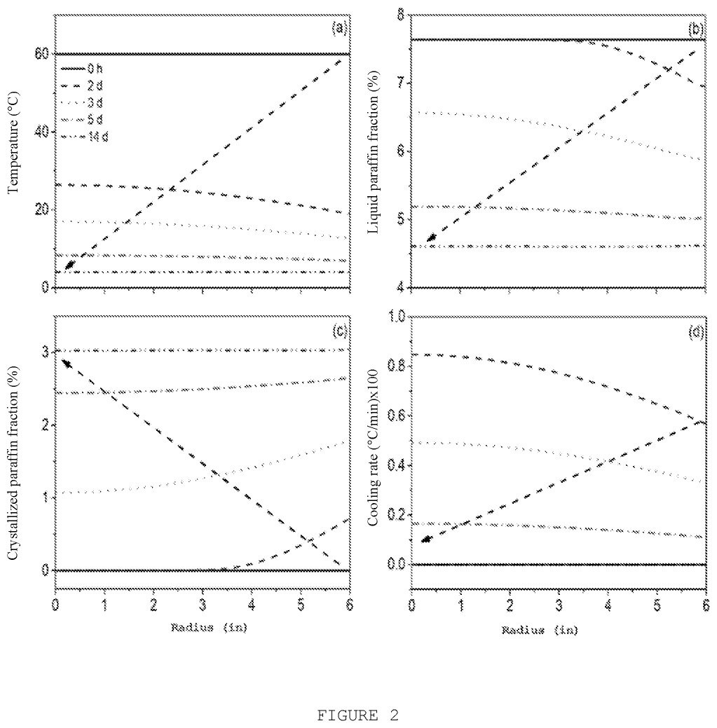

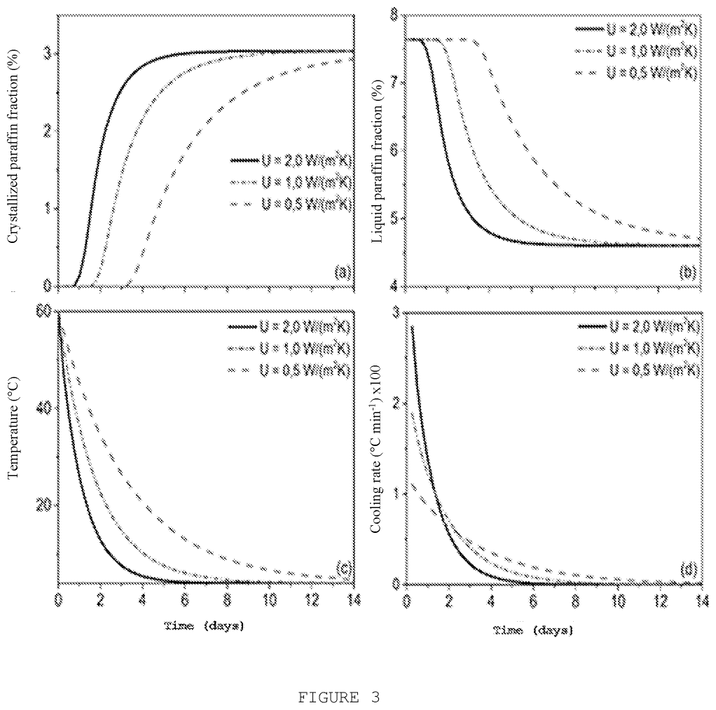

In general, based on differential scanning calorimetry data and rheological behavior, the kinetic behavior of the studied samples was evaluated by simulations of paraffinic oil production stoppages in a pipeline. The temperature profile, the paraffin fractions in the solid (crystallized) and liquid phases and the cooling rate were simulated in the period from zero to 14 days of quiescent cooling, for different heat exchange global coefficients (FIG. 2). Furthermore, the average yield stress profiles for oils with different precipitated paraffin fractions and the variation of the critical stress along the straight cross-section of the tube were obtained (FIG. 3).

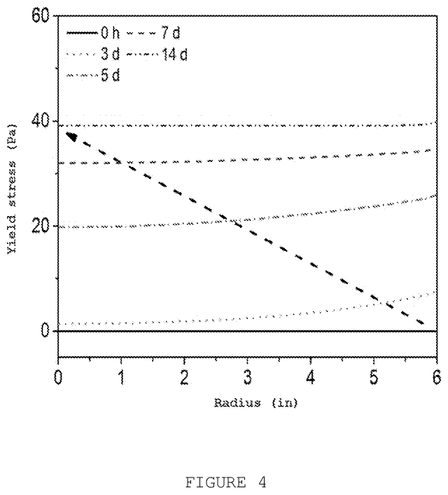

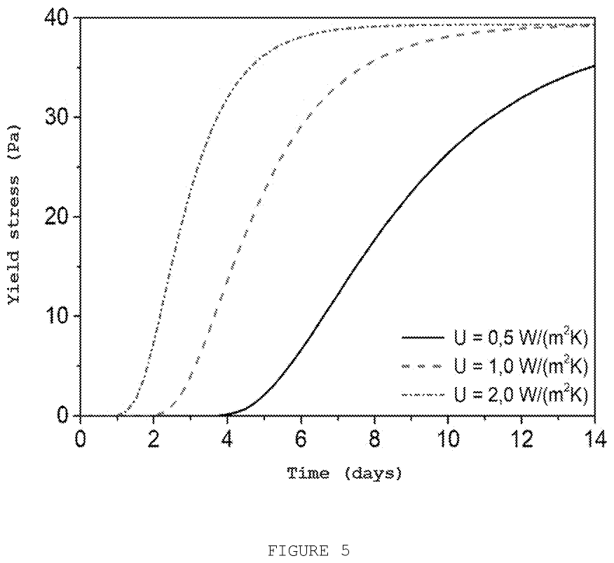

Based on the profiles obtained in FIG. 3, it is observed that the speed of evolution of these profiles depends on the characteristics of the tube, the type of thermal insulation and also the external cooling conditions, which are incorporated into the simulation through the thermal exchange global coefficient U. Another relevant characteristic of these profiles is that most of the crystallization occurs in the first days of cooling, which after this stage slowly evolves to a constant level of precipitated fraction. FIGS. 4 and 5 show the consequence of the evolution of the paraffin profile precipitated in the TLE, which can be calculated for field application purposes, as the average of the stress radial profile. The characteristics of these average profiles are similar to the precipitated paraffin profile, which grows rapidly in the first days of cooling and tends to a plateau, which is a function of the amount of paraffin present in the oil. The main characteristic of stress radial profiles is that they evolve from the wall to the center of the tube, with TLE variability in the cross section during cooling.

### Simulation Description

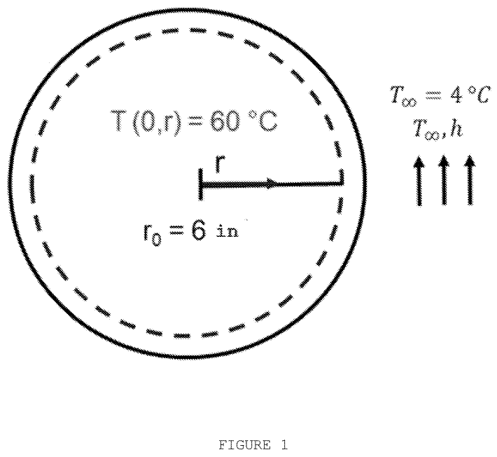

The method proposed through equations 1 to 6 was applied in simulations of paraffinic oil production stoppages in the cross section of a pipeline, under the assumption of quiescent cooling. For this, an initial temperature of 60° C., a radius of 6 inches and an external seabed temperature of 4° C. were assumed, as shown in FIG. 1, where T(0,r)=Initial temperature, r₀=Radius of the tube, h=convection coefficient and T_{∞}=External seabed temperature.

The model for this simulation consists of the mass balance of crystallized paraffin fraction (ϕ_{PS}), the mass balance of liquid paraffin fraction ((P_{PL}) and the energy balance in the section, represented by temperature (T).

Firstly, the kinetic model was adapted to the cooling problem in the section, according to Equations 7 to 10, in which R_{ϕ} is the crystallization rate, t is the cooling time and r is the radial coordinate.

$$\\ \begin{matrix}\frac{\partial {ϕ}_{PS}}{\partial t} = {R}_{ϕ} & ( Eq . 7 )\end{matrix}$$

$$\\ \begin{matrix}t = 0 ∴ {ϕ}_{PS} ( t , r ) = 0 ∀ r & ( Eq . 8 )\end{matrix}$$

$$\\ \begin{matrix}T \geq {T}_{inicial} ∴ {R}_{ϕ} = 0 & ( Eq . 9 )\end{matrix}$$

$$\\ \begin{matrix}T < {T}_{inicial} ∴ {R}_{ϕ} = ( - \frac{\partial T}{\partial t} ) k ( T ) {ϕ}_{PL} & ( Eq . 10 )\end{matrix}$$

To describe the heat transfer in the tube section, a transient energy balance was adopted considering the radial dispersion of heat with the pipe, subject to a heat exchange global coefficient, according to Equations 11 to 14. In this balance, ρ represents the oil density, Cₚ the heat capacity, k_{eff} the thermal conductivity, t is the time, r is the radial coordinate, T_{∞} the temperature outside the tube, U the heat exchange global coefficient and r₀ the radius of the tube:

$$\\ \begin{matrix}ρ {C}_{p} \frac{\partial T}{\partial t} = \frac{1}{r} \frac{\partial }{\partial r} ( {rk}_{eff} \frac{dT}{dr} ) + ρ θ & ( Eq . 11 )\end{matrix}$$

$$\\ \begin{matrix}t = 0 ∴ T ( 0 , r ) = {T}_{0} , ∀ r & ( Eq . 12 )\end{matrix}$$

$$\\ \begin{matrix}r = 0 ∴ \frac{\partial T}{\partial r} ( t , 0 ) = 0 , ∀ t & ( Eq . 13 )\end{matrix}$$

$$\\ \begin{matrix}r = {r}_{0} ∴ - {k}_{eff} \frac{\partial T}{\partial r} ( t , {r}_{0} ) = U ( T ( t , {r}_{0} ) - {T}_{∞} ) , ∀ t & ( Eq . 14 )\end{matrix}$$

For industrial application purposes, the U coefficient can be explained in terms of the characteristics of the tube, namely the thickness and conductivity of the wall and the insulating material and the external convection coefficient.

Finally, the mass balance for the liquid paraffin fraction, also with radial dispersion, was coupled to the model. As hypotheses, the absence of mass flow in the tube wall was adopted and that the proposed kinetic model acts as a source term, removing the crystallized paraffin fraction from the liquid phase. Equations 15 to 18 represent the model, in which ϕ_{PL} is the liquid paraffin fraction and D_{iff} is the diffusivity of paraffin in the oil.

$$\\ \begin{matrix}\frac{\partial {ϕ}_{PL}}{\partial t} = \frac{1}{r} \frac{\partial }{\partial r} ( {rD}_{iff} \frac{\partial {ϕ}_{PL}}{\partial r} ) - {R}_{ϕ} & ( Eq . 15 )\end{matrix}$$

$$\\ \begin{matrix}t = 0 ∴ {ϕ}_{PL} ( 0 , r ) = {ϕ}_{PL , 0} , ∀ r & ( Eq . 16 )\end{matrix}$$

$$\\ \begin{matrix}r = 0 ∴ \frac{\partial {ϕ}_{PL}}{\partial r} ( t , 0 ) = 0 , ∀ t & ( Eq . 17 )\end{matrix}$$

$$\\ \begin{matrix}r = {r}_{0} ∴ \frac{\partial {ϕ}_{PL}}{\partial r} ( t , {r}_{0} ) = 0 , ∀ t & ( Eq . 18 )\end{matrix}$$

To solve these equations, the diffusive terms were discretized using the finite volume method and the resulting differential equations were integrated over time to obtain the temporal profiles. It is important to highlight that the proposed simulation can, without loss of validity, be carried out in commercial flow simulators, adding the kinetic model as a source term for the mass balance and applying rheological models to calculate the flow stress profiles as a post-processing step.

### List of Parameters Used in the Simulation

The parameters used in the simulations, obtained with the parameter estimation procedure from rheological and calorimetry data, are in Table 1.

TABLE 1
Parameters obtained for the proposed model

| Parameter | Value obtained in the estimate |
|---|---|
| k_{AR} (1/K) | 0.028 |
| A_{AT} (1/K) | 3.51 |
| E_{AT}/R (K) | 21.54 |
| ϕ₀ (—) | 0.0777 |
| C_{τ} (Pa) | 1.60 |
| D (—) | 2.37 |

The other parameters used represent typical values for the properties of paraffinic oils indicated in Mendes et al. [7] and Mehrotra et al. [15], according to Table 2.

TABLE 2
Other parameters used in the simulation

| Parameter | Value obtained in the estimate |
|---|---|
| k_{eff} (W/m/K) | 0.17 |
| Cₚ (J/kg/K) | 2100 |
| ρ (kg/m³) | 800 |
| D_{iff}(—) | 1 × 10⁻¹⁰ |
| T₀ (° C.) | 60 |
| r₀ (pol) | 6 |
| T_{inicial} (° C.) | 26.1 |

### Demonstration of Results for the Simulation in the Tube

As the first result of the proposed simulations, the radial profiles of temperature, paraffin fraction in the liquid phase, solid/crystallized paraffin fraction and cooling rate over 14 days of cooling for a crude sample supplied by Petrobras are presented in FIG. 2. Furthermore, to obtain these results, a heat exchange global coefficient of 1 W/(m²K) was used. Initially, it is observed that the temperature profiles gradually decrease from the beginning of the simulation, however the paraffin profiles in the liquid and crystallized phases only show some dynamics after the temperature reaches the initial temperature at which the crystals appear. From this point onwards, a reduction in the paraffin fraction in the liquid phase and an increase in the crystallized paraffin fraction are observed due to the phase change of the material. It is also possible to observe cooling rate values in the order of 0.01° C./min, which corroborates the values found in field situations (Zougari and Sopkow [8]).

From the radial profiles, the average profiles in the section are calculated over time, as shown in FIG. 3. The results corroborate previous observations that the paraffin fraction profiles only evolve after the temperature reaches the temperature at which the crystals appear. However, the profiles presented also show the effect of the exchange global coefficient on the cooling and crystallization speed of the paraffins. It is observed that for an exchange coefficient of 2 W/(m²K), the section reaches an external temperature value of 4° C. after 6 days of stoppage and that the paraffins begin to crystallize in less than 1 day of cooling. On the other hand, for a coefficient of 0.5 W/m²K, more than 14 days are needed to completely cool the section and more than 3 days for the paraffins to begin the crystallization process.

Similarly, using rheological models as a post-processing step for the results, radial and average yield stress profiles are obtained from the radial profiles of crystallized paraffin fraction, as shown in FIGS. 4 and 5.

The stress profiles presented in FIGS. 4 and 5 make it possible to estimate the Available Waiting Time (TED) as a function of the evolution of the Yield Stress (TLE), which, in its turn, can be used to estimate the minimum pressure required to restart the flow. As an example, using FIG. 5 as a reference, it is observed that the increase in TLE in the section only occurs from the 4^{th} day onwards for the exchange coefficient of 0.5 W/(m²K) and with 2 days and 1 day for the coefficients of 1 and 2 W/(m²K), respectively. From this information, operational criteria can be developed based on the maximum pressure available to resume flow, considering the diameter of the line and the length of the section with gelled material.

Therefore, the ability to predict the evolution of the precipitated paraffin fraction together with the viscoelastic properties of paraffinic oils under cooling conditions inside submarine pipes is of great use:
In the design of the pumping system in terms of the appropriate choice of pumps, diameters, internal treatment of the pipes;
Estimation of how long the production operation can be stopped before the line is completely blocked;
Better scheduling of mechanical deposit removal operations (also known as pigging) or other forms of intervention;
Estimation of the pressure required to restart production after the stoppage period;
Estimation of fluid flow after restarting production.

In this way, a reduction in oil production losses resulting from the occurrence of blockages by paraffinic oil in subsea lines during a production stoppage is expected and, also, a safer, more economical and efficient production.

### REFERENCES

[1] A. B. Hansen, E. Larsen, W. B. Pedersen, A. B. Nielsen, and H. P. RØnningsen, “Wax Precipitation from North Sea Crude Oils. 3. Precipitation and Dissolution of Wax Studied by Differential Scanning Calorimetry,” Energy and Fuels, vol. 5, no. 6, pages 914 to 923, 1991.
[2] Visintin, R. F. G.; Lapasin, R.; Vignati, E.; D'Antona, P.; Lockhart, T. P. Rheological Behavior and Structural Interpretation of Waxy Crude Oil Gels. Langmuir 2005, 21 (14), 6240 to 6249.
[3] Paso, K.; Senra, M.; Yi, Y.; Sastry, A. M.; Fogler, H. S. Paraffin Polydispersity Facilitates Mechanical Gelling. Industrial and Engineering Chemistry Research 2005, 44 (18), 7242 to 7254.
[4] D. Tukenov, “Nanochemistry Drives New Method for Removal and Control of Wax,” J. Pet. Technol., vol. 61, no. 2, pages 77 to 88, 2015.
[5] Bhat, N. V., Mehrotra, A. K. Modeling of deposit formation from “waxy” mixtures via moving boundary formulation: Radial heat transfer under static and laminar flow conditions.” Industrial & engineering chemistry research 2005, 44(17), 6948 to 6962.
[6] Fleming, F. P., Daridon, J. L., Azevedo, L. F. A., & Pauly, J. Direct adjustment of wax thermodynamic model parameter to micro Differential Scanning Calorimetry thermograms. Fluid Phase Equilibria 2017, 436, 20 to 29.
[7] Mendes, R., Vinay, G., & Coussot, P. Yield stress and minimum pressure for simulating the flow restart of a waxy crude oil pipeline. Energy & Fuels 2017, 31(1), 395 to 407.
[8] Zougari, M. I., & Sopkow, T. Introduction to crude oil wax crystallization kinetics: Process modeling. Industrial & engineering chemistry research 2007, 46(4), 1360 to 1368.
[9] Yansong Zhao, Kristofer Paso & Johan Sjöblom, Thermal behavior and solid fraction dependent gel strength model of waxy oils. J Therm Anal Calorim (2014) 117:403 to 411.
[10] Y. Zhao, K. Paso, J. Norrman, H. Ali, G. Sørland, and J. Sjöblom, “Utilization of DSC, NIR, and NMR for wax appearance temperature and chemical additive performance characterization,” J. Therm. Anal. Calorim., vol. 120, no. 2, pages 1427 to 1433, 2015.
[11] Shih, W. H., Shih, W. Y., Kim, S. I., Liu, J., & Aksay, I. A. Scaling behavior of the elastic properties of colloidal gels. Physical review A 1990, 42(8), 4772.
[12] Huang, Z., Lee, H. S., Senra, M., & Scott Fogler. A fundamental model of wax deposition in subsea oil pipelines. AIChE Journal 2011, 57(11), 2955 to 2964.
[13] Guimarães, A. S. Determinação de propriedades reológicas de óleos parafinicos baseada na teoria de objetos fractais. Dissertação de mestrado, PEQ/COPPE/UFRJ, 2021.
[14] Marinho, T. O. Rheological behavior and structural interpretation of model waxy oil under gelling conditions. Tese de doutorado, PEQ/COPPE/UFRJ, 2021.
[15] Mehrotra, A. K., Ehsani, S., Haj-Shafiei, S., & Kasumu, A. S. (2020). A review of heat-transfer mechanism for solid deposition from “waxy” or paraffinic mixtures. The Canadian Journal of Chemical Engineering, 98(12), 2463 to 2488.

1. A method for predicting restart of paraffinic oil, comprising determining yield stress (TLE) through parameters of differential scanning calorimetry (DSC) tests and rheological evaluation of precipitated paraffin fraction under production stoppage conditions.

2. The method of claim 1 further comprising determining heat flow corresponding to phase transition of paraffins through differential scanning calorimetry tests.

3. The method of claim 1, wherein carrying out the rheological evaluation comprises conducting oscillatory stress amplitude scanning tests in rheometers at specified temperatures below gelling temperature in conjunction with differential scanning calorimetry tests.

4. The method of claim 1, wherein obtaining an estimate of the precipitated paraffin fraction is conducted according to Equations 1 to 5:
$$\\ \begin{matrix}\frac{d {ϕ}_{PS}}{dT} = k ( {ϕ}_{0} - {ϕ}_{PS} ) , {ϕ}_{PS} ( {T}_{initial} ) = 0 & ( Eq . 1 )\end{matrix}$$
$$\\ \begin{matrix}θ = Δ {h}_{c} q \frac{d {ϕ}_{PS}}{dT} , θ ( 0 ) = 0 & ( Eq . 2 )\end{matrix}$$
$$\\ \begin{matrix}T = - qt + {T}_{initial} & ( Eq . 3 )\end{matrix}$$
$$\\ \begin{matrix}k = \frac{{k}_{AT} {k}_{AR}}{{k}_{AT} + {k}_{AR}} & ( Eq . 4 )\end{matrix}$$
$$\\ \begin{matrix}{k}_{AT} = {A}_{AT} exp [ \frac{- {E}_{AT}}{R ( {T}_{initial} - T )} ] & ( Eq . 5 )\end{matrix}$$
wherein ϕ_{PS} is the precipitated paraffin fraction and e represents heat flow corresponding to phase transition of paraffins;
wherein Δh_{c} is an average value of enthalpy of pure paraffin corresponding to 200 J/g, q is cooling rate applied in the differential scanning calorimetry experiment, R is gas universal constant, T is temperature, t is time and ϕ₀, A_{AT}, E_{AT} and k_{AR} are parameters to be determined through an adjustment of heat flow data from differential scanning calorimetry tests.

5. The method of claim 4, comprising adjusting paraffin fraction data with rheological data, according to Equation 6:
$$\\ \begin{matrix}{τ}_{c} = {C}_{τ} {ϕ}_{PS}^{{}^{} A} , A = \frac{2}{3 - D} & ( Eq . 6 )\end{matrix}$$
wherein (C_{τ}) is a proportionality factor and (D) is a structure factor or fractal dimension.

6. The method of claim 5, wherein equations 1 to 6 are incorporated into flow assurance and computational fluid dynamics simulators for the prediction of stress fields and production stoppage time.

7. The method of claim 5, further comprising determining cooling of a piping section through the following Equations 7 to 18:
Energy balance:
$$\\ \begin{matrix}ρ {C}_{p} \frac{\partial T}{\partial t} = \frac{1}{r} \frac{\partial }{\partial r} ( {rk}_{eff} \frac{dT}{dr} ) + ρ Δ {h}_{c} {R}_{ϕ} & ( Eq . 7 )\end{matrix}$$
$$\\ \begin{matrix}t = 0 ∴ T ( 0 , r ) = {T}_{0} , ∀ r & ( Eq . 8 )\end{matrix}$$
$$\\ \begin{matrix}r = 0 ∴ \frac{\partial T}{\partial r} ( t , 0 ) = 0 , ∀ t & ( Eq . 9 )\end{matrix}$$
$$\\ \begin{matrix}r = {r}_{0} ∴ - {k}_{eff} \frac{\partial T}{\partial r} ( t , {r}_{0} ) = U ( T ( t , {r}_{0} ) - {T}_{∞} ) , ∀ t & ( Eq . 10 )\end{matrix}$$
wherein T is the temperature, t is the time, ρ is mixture density, Cₚ is heat capacity of a mixture, R_{ϕ} is a source term corresponding to a kinetic model, r is a radial variable, k_{eff} is a thermal conductivity of the mixture, U is a heat exchange global coefficient, T_{∞} is a sea temperature and T₀ is an initial temperature of a fluid;
$$\\ \begin{matrix}\frac{\partial {ϕ}_{PL}}{\partial t} = \frac{1}{r} \frac{\partial }{\partial r} ( {rD}_{iff} \frac{\partial {ϕ}_{PL}}{\partial r} ) - {R}_{ϕ} & ( Eq . 11 )\end{matrix}$$
$$\\ \begin{matrix}t = 0 ∴ {ϕ}_{PL} ( 0 , r ) = {ϕ}_{PL , 0} , ∀ r & ( Eq . 12 )\end{matrix}$$
$$\\ \begin{matrix}r = 0 ∴ \frac{\partial {ϕ}_{PL}}{\partial r} ( t , 0 ) = 0 , ∀ t & ( Eq . 13 )\end{matrix}$$
$$\\ \begin{matrix}r = {r}_{0} ∴ \frac{\partial {ϕ}_{PL}}{\partial r} ( t , {r}_{0} ) = 0 , ∀ t & ( Eq . 14 )\end{matrix}$$
wherein (ϕ_{PL}) corresponds to the balance of paraffin in a liquid phase, in which D_{iff} is a mass diffusivity of paraffin in the liquid phase and ϕ_{PL,0} is an initial fraction of paraffin in the liquid phase; and
$$\\ \begin{matrix}\frac{\partial {ϕ}_{PS}}{\partial t} = {R}_{ϕ} & ( Eq . 15 )\end{matrix}$$
$$\\ \begin{matrix}t = 0 ∴ {ϕ}_{PS} ( t , r ) = 0 ∀ r & ( Eq . 16 )\end{matrix}$$
$$\\ \begin{matrix}T \geq TIAC ∴ {R}_{ϕ} = 0 & ( Eq . 17 )\end{matrix}$$
$$\\ \begin{matrix}T < TIAC ∴ {R}_{ϕ} = ( - \frac{\partial T}{\partial t} ) k ( T ) ( {ϕ}_{PL} - {ϕ}^{*} ( T ) ) & ( Eq . 18 )\end{matrix}$$
wherein (ϕ_{PS}) represents the balance of precipitated paraffin, in which TIAC is the initial temperature at which crystals appear.

8. The method of claim 7, wherein a temperature profile, the paraffin fractions in solid and liquid phases, and the cooling rate were simulated in a period from zero to 14 days of quiescent cooling, for different heat exchange global coefficients.

9. The method of claim 8, wherein average yield stress profiles for oils with different precipitated paraffin fractions and variation of critical stress were obtained along a straight transverse section of a tube.

10. The method of claim 9, wherein kinetic behavior of samples, obtained through differential exploratory calorimetry and rheological behavior data, was evaluated by simulations of paraffinic oil production stoppages in an underwater pipeline.
